(19) United States
(12) Patent Application Publication
(10) Pub. No.: US 2012/0026940 A1
(43) Pub. Date: Feb. 2, 2012

(54) RADIO REPORTING SET AND BACKHAUL REPORTING SET CONSTRUCTION FOR COORDINATED MULTI-POINT COMMUNICATION

(75) Inventors: Alan Barbieri, San Diego, CA (US); Alexei Yurievitch Gorokhov, San Diego, CA (US); Siddhartha Mallik, San Diego, CA (US)

(73) Assignee: QUALCOMM Incorporated, San Diego, CA (US)

(21) Appl. No.: 13/018,980

(22) Filed: Feb. 1, 2011

Related U.S. Application Data
(60) Provisional application No. 61/300,706, filed on Feb. 2, 2010.
(60) Provisional application No. 61/300,710, filed on Feb. 2, 2010.

(51) Int. Cl. H04W 84/00

(52) U.S. Cl. 370/328

(57) ABSTRACT

Systems, methods, apparatus and articles of manufacture are disclosed for constructing radio reporting sets and backhaul reporting sets for coordinated multi-point transmission in a wireless communication network.

### RELATED APPLICATIONS

### Claim of Priority Under 35 U.S.C. §119

The present application for patent claims priority to Provisional Application No. 61/300,706, entitled “Backhaul Reporting Set Construction for CoMP,” filed Feb. 2, 2010, assigned to the assignee hereof and expressly incorporated herein by reference. The present application for patent also claims priority to Provisional Application No. 61/300,710, entitled “Radio Reporting Set Construction for CoMP,” filed Feb. 2, 2010, assigned to the assignee hereof and expressly incorporated herein by reference.

### TECHNICAL FIELD

Embodiments of the present invention relate to coordinated multi-point communication systems in general, and in particular to methods, apparatus and systems for managing cooperating and interfering nodes in a coordinated multi-point communication system.

### BACKGROUND

Downlink Cooperative Multi-Point (CoMP) transmission is proposed for LTE Advanced cellular networks. Downlink CoMP employs cooperative transmission from multiple network nodes (e.g., access points, cells or eNBs) to a user equipment (UE) or multiple UEs so that inter-node interference is minimized and/or channel gain from multiple nodes is combined at the UE receiver to maximize useable power. CoMP implementations may involve over-the-backhaul (OTB) interactions between various nodes within the communication network.

### SUMMARY

Disclosed embodiments relate to systems, methods, apparatus and articles of manufacture for selecting a radio reporting set of nodes from a measurement set of nodes in a communication network, propagating channel information on the radio reporting set of nodes to adjacent nodes in the communication network, selecting a backhaul reporting set of nodes based on a measure of utility derived from the channel information and implementing a cooperative multi-point transmission in a transmission set of nodes selected from the backhaul reporting set of nodes.

Other disclosed embodiments relate to systems, methods, apparatus and articles of manufacture for detecting a plurality of nodes in a communication network, selecting a subset of the plurality of nodes based on a utility of incorporating the subset in a communication group and reporting the subset within the communication network.

These and other features of various embodiments, together with the organization and manner of operation thereof, will become apparent from the following detailed description when taken in conjunction with the accompanying drawings, in which like reference numerals are used to refer to like parts throughout.

### BRIEF DESCRIPTION OF THE DRAWINGS

Provided embodiments are illustrated by way of example, and not of limitation, in the figures of the accompanying drawings in which:

FIG. 1 illustrates a wireless communication system in one embodiment;

FIG. 2 illustrates a block diagram of a communication system in one embodiment;

FIG. 3 is a chart illustrating an exemplary method for selecting a radio reporting set;

FIG. 4 is a flowchart illustrating an exemplary method for constructing a radio reporting set;

FIG. 5 is a diagram illustrating an exemplary method for constructing a backhaul reporting set;

FIG. 6 is a diagram illustrating an exemplary network;

FIG. 7 is a flowchart illustrating an exemplary method for constructing a backhaul reporting set;

FIG. 8 is a flowchart illustrating an exemplary method for extending a backhaul reporting set;

FIG. 9 is a block diagram illustrating an exemplary system capable of implementing various disclosed embodiments; and

FIG. 10 illustrates an exemplary apparatus capable of implementing various disclosed embodiments.

### DETAILED DESCRIPTION

In the following description, for purposes of explanation and not limitation, details and descriptions are set forth in order to provide a thorough understanding of the various disclosed embodiments. However, it will be apparent to those skilled in the art that the various embodiments may be practiced in other embodiments that depart from these details and descriptions.

As used herein, the terms “component,” “module,” “system” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, certain embodiments are described herein in connection with a user equipment. A user equipment can also be called a user terminal, and may contain some or all of the functionality of a system, subscriber unit, subscriber station, mobile station, mobile wireless terminal, mobile device, node, device, remote station, remote terminal, terminal, wireless communication device, wireless communication apparatus or user agent. A user equipment can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with one or more wireless terminals and can also be called, and may contain some or all of the functionality of, an access point, node, Node B, evolved NodeB (eNB) or some other network entity. A base station communicates over the air-interface with wireless terminals. The communication may take place through one or more sectors. The base station can act as a router between the wireless terminal and the rest of the access network, which can include an Internet Protocol (IP) network, by converting received air-interface frames to IP packets. The base station can also coordinate management of attributes for the air interface, and may also be the gateway between a wired network and the wireless network.

Various aspects, embodiments or features will be presented in terms of systems that may include a number of devices, components, modules, and the like. It is to be understood and appreciated that the various systems may include additional devices, components, modules, and so on, and/or may not include all of the devices, components, modules and so on, discussed in connection with the figures. A combination of these approaches may also be used.

Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

The various disclosed embodiments may be incorporated into a communication system. In one example, such communication system utilizes an orthogonal frequency division multiplex (OFDM) that effectively partitions the overall system bandwidth into multiple (N_{F}) subcarriers, which may also be referred to as frequency sub-channels, tones or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval, which may be dependent on the bandwidth of each frequency subcarrier, a modulation symbol may be transmitted on each of the N_{F} frequency subcarriers. Thus, OFDM may be used to combat inter-symbol interference (ISI) caused by frequency selective fading, which is characterized by different amounts of attenuation across the system bandwidth.

Generally, a wireless multiple-access communication system can simultaneously support communication for multiple wireless terminals. Each terminal communicates with one or more base stations through transmissions on the forward and reverse links. The forward link (or downlink) refers to the communication link from the base stations to the terminals, and the reverse link (or uplink) refers to the communication link from the terminals to the base stations. This communication link can be established through a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station.

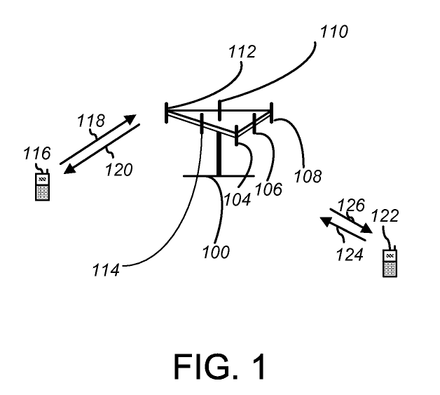

FIG. 1 illustrates a wireless communication system within which the various disclosed embodiments may be implemented. A base station 100 may include multiple antenna groups, and each antenna group may comprise one or more antennas. For example, if the base station 100 comprises six antennas, one antenna group may comprise a first antenna 104 and a second antenna 106, another antenna group may comprise a third antenna 108 and a fourth antenna 110, while a third group may comprise a fifth antenna 112 and a sixth antenna 114. It should be noted that while each of the above-noted antenna groups were identified as having two antennas, more or fewer antennas may be utilized in each antenna group.

Referring back to FIG. 1, a first user equipment 116 is illustrated to be in communication with, for example, the fifth antenna 112 and the sixth antenna 114 to enable the transmission of information to the first user equipment 116 over a first forward link 120, and the reception of information from the first user equipment 116 over a first reverse link 118. FIG. 1 also illustrates a second user equipment 122 that is in communication with, for example, the third antenna 108 and the fourth antenna 110 to enable the transmission of information to the second user equipment 122 over a second forward link 126, and the reception of information from the second user equipment 122 over a second reverse link 124. In a Frequency Division Duplex (FDD) system, the communication links 118, 120, 124 126 that are shown in FIG. 1 may use different frequencies for communication. For example, the first forward link 120 may use a different frequency than that used by the first reverse link 118.

In some embodiments, each group of antennas and/or the area in which they are designed to communicate is often referred to as a sector of the base station. For example, the different antenna groups that are depicted in FIG. 1 may be designed to communicate to the user equipment in a sector of the base station 100. In communication over the forward links 120 and 126, the transmitting antennas of the base station 100 utilize beamforming in order to improve the signal-to-noise ratio of the forward links for the different user equipment 116 and 122. Also, a base station that uses beamforming to transmit to user equipment scattered randomly throughout its coverage area causes less interference to user equipment in the neighboring cells than a base station that transmits omni-directionally through a single antenna to all its user equipment.

The communication networks that may accommodate some of the various disclosed embodiments may include logical channels that are classified into Control Channels and Traffic Channels. Logical control channels may include a broadcast control channel (BCCH), which is the downlink channel for broadcasting system control information, a paging control channel (PCCH), which is the downlink channel that transfers paging information, a multicast control channel (MCCH), which is a point-to-multipoint downlink channel used for transmitting multimedia broadcast and multicast service (MBMS) scheduling and control information for one or several multicast traffic channels (MTCHs). Generally, after establishing radio resource control (RRC) connection, MCCH is only used by the user equipments that receive MBMS. Dedicated control channel (DCCH) is another logical control channel that is a point-to-point bi-directional channel transmitting dedicated control information, such as user-specific control information used by the user equipment having an RRC connection. Common control channel (CCCH) is also a logical control channel that may be used for random access information. Logical traffic channels may comprise a dedicated traffic channel (DTCH), which is a point-to-point bi-directional channel dedicated to one user equipment for the transfer of user information. Also, a multicast traffic channel (MTCH) may be used for point-to-multipoint downlink transmission of traffic data.

The communication networks that accommodate some of the various embodiments may additionally include logical transport channels that are classified into downlink (DL) and uplink (UL). The DL transport channels may include a broadcast channel (BCH), a downlink shared data channel (DL-SDCH), a multicast channel (MCH) and a Paging Channel (PCH). The UL transport channels may include a random access channel (RACH), a request channel (REQCH), an uplink shared data channel (UL-SDCH) and a plurality of physical channels. The physical channels may also include a set of downlink and uplink channels.

In some disclosed embodiments, the downlink physical channels may include at least one of a common pilot channel (CPICH), a synchronization channel (SCH), a common control channel (CCCH), a shared downlink control channel (SDCCH), a multicast control channel (MCCH), a shared uplink assignment channel (SUACH), an acknowledgement channel (ACKCH), a downlink physical shared data channel (DL-PSDCH), an uplink power control channel (UPCCH), a paging indicator channel (PICH), a load indicator channel (LICH), a physical broadcast channel (PBCH), a physical control format indicator channel (PCFICH), a physical downlink control channel (PDCCH), a physical hybrid ARQ indicator channel (PHICH), a physical downlink shared channel (PDSCH) and a physical multicast channel (PMCH). The uplink physical channels may include at least one of a physical random access channel (PRACH), a channel quality indicator channel (CQICH), an acknowledgement channel (ACKCH), an antenna subset indicator channel (ASICH), a shared request channel (SREQCH), an uplink physical shared data channel (UL-PSDCH), a broadband pilot channel (BPICH), a physical uplink control channel (PUCCH) and a physical uplink shared channel (PUSCH).

Further, the following terminology and features may be used in describing the various disclosed embodiments:

3G 3rd Generation

3GPP 3rd Generation Partnership Project

ACLR Adjacent channel leakage ratio

ACPR Adjacent channel power ratio

ACS Adjacent channel selectivity

ADS Advanced Design System

AMC Adaptive modulation and coding

A-MPR Additional maximum power reduction

ARQ Automatic repeat request

BCCH Broadcast control channel

BTS Base transceiver station

CDD Cyclic delay diversity

CCDF Complementary cumulative distribution function

CDMA Code division multiple access

CFI Control format indicator

Co-MIMO Cooperative MIMO

CP Cyclic prefix

CPICH Common pilot channel

CPRI Common public radio interface

CQI Channel quality indicator

CRC Cyclic redundancy check

DCI Downlink control indicator

DFT Discrete Fourier transform

DFT-SOFDM Discrete Fourier transform spread OFDM

DL Downlink (base station to subscriber transmission)

DL-SCH Downlink shared channel

DSP Digital signal processing

DT Development toolset

DVSA Digital vector signal analysis

EDA Electronic design automation

E-DCH Enhanced dedicated channel

E-UTRAN Evolved UMTS terrestrial radio access network

eMBMS Evolved multimedia broadcast multicast service

eNB Evolved Node B

EPC Evolved packet core

EPRE Energy per resource element

ETSI European Telecommunications Standards Institute

E-UTRA Evolved UTRA

E-UTRAN Evolved UTRAN

EVM Error vector magnitude

FDD Frequency division duplex

FFT Fast Fourier transform

FRC Fixed reference channel

FS1 Frame structure type 1

FS2 Frame structure type 2

GSM Global system for mobile communication

HARQ Hybrid automatic repeat request

HDL Hardware description language

HI HARQ indicator

HSDPA High speed downlink packet access

HSPA High speed packet access

HSUPA High speed uplink packet access

IFFT Inverse FFT

IOT Interoperability test

IP Internet protocol

LO Local oscillator

LTE Long term evolution

MAC Medium access control

MBMS Multimedia broadcast multicast service

MBSFN Multicast/broadcast over single-frequency network

MCH Multicast channel

MIMO Multiple input multiple output

MISO Multiple input single output

MME Mobility management entity

MOP Maximum output power

MPR Maximum power reduction

MU-MIMO Multiple user MIMO

NAS Non-access stratum

OBSAI Open base station architecture interface

OFDM Orthogonal frequency division multiplexing

OFDMA Orthogonal frequency division multiple access

PAPR Peak-to-average power ratio

PAR Peak-to-average ratio

PBCH Physical broadcast channel

P-CCPCH Primary common control physical channel

PCFICH Physical control format indicator channel

PCH Paging channel

PDCCH Physical downlink control channel

PDCP Packet data convergence protocol

PDSCH Physical downlink shared channel

PHICH Physical hybrid ARQ indicator channel

PHY Physical layer

PRACH Physical random access channel

PMCH Physical multicast channel

PMI Pre-coding matrix indicator

P-SCH Primary synchronization signal

PUCCH Physical uplink control channel

PUSCH Physical uplink shared channel.

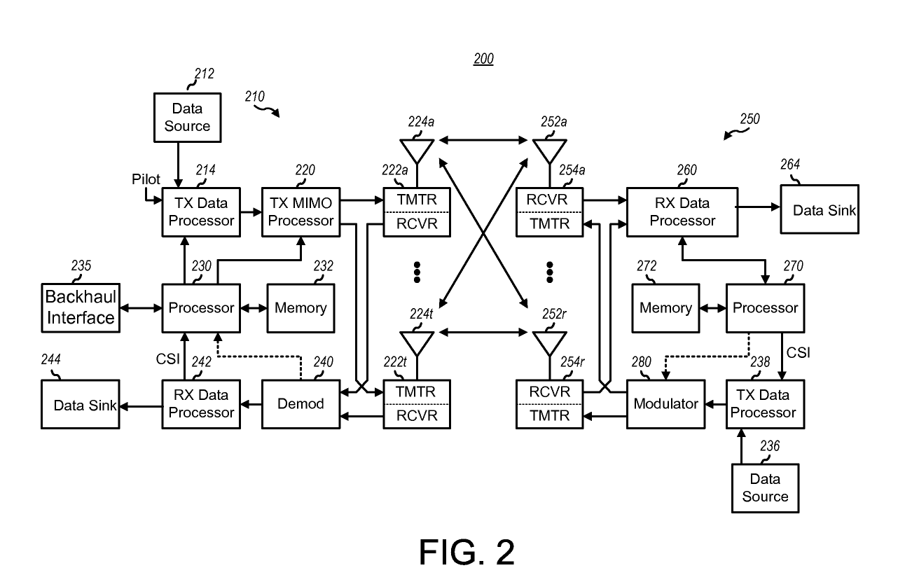

FIG. 2 illustrates a block diagram of an exemplary communication system that may accommodate the various embodiments. The MIMO communication system 200 that is depicted in FIG. 2 comprises a transmitter system 210 (e.g., a base station or access point) and a receiver system 250 (e.g., an access terminal or user equipment) in a MIMO communication system 200. It will be appreciated by one of ordinary skill that even though the base station is referred to as a transmitter system 210 and a user equipment is referred to as a receiver system 250, as illustrated, embodiments of these systems are capable of bi-directional communications. In that regard, the terms “transmitter system 210” and “receiver system 250” should not be used to imply single directional communications from either system. It should also be noted the transmitter system 210 and the receiver system 250 of FIG. 2 are each capable of communicating with a plurality of other receiver and transmitter systems that are not explicitly depicted in FIG. 2. At the transmitter system 210, traffic data for a number of data streams is provided from a data source 212 to a transmit (TX) data processor 214. Each data stream may be transmitted over a respective transmitter system. The TX data processor 214 formats, codes and interleaves the traffic data for each data stream, based on a particular coding scheme selected for that data stream, to provide the coded data.

The coded data for each data stream may be multiplexed with pilot data using, for example, OFDM techniques. The pilot data is typically a known data pattern that is processed in a known manner and may be used at the receiver system to estimate the channel response. The multiplexed pilot and coded data for each data stream is then modulated (symbol mapped) based on a particular modulation scheme (e.g., BPSK, QSPK, M-PSK or M-QAM) selected for that data stream to provide modulation symbols. The data rate, coding and modulation for each data stream may be determined by instructions performed by a processor 230 of the transmitter system 210.

In the exemplary block diagram of FIG. 2, the modulation symbols for all data streams may be provided to a TX MIMO processor 220, which can further process the modulation symbols (e.g., for OFDM). The TX MIMO processor 220 then provides N_{T} modulation symbol streams to N_{T} transmitter system transceivers (TMTR) 222a through 222t. In one embodiment, the TX MIMO processor 220 may further apply beamforming weights to the symbols of the data streams and to the antenna from which the symbol is being transmitted.

Each transmitter system transceiver 222a through 222t receives and processes a respective symbol stream to provide one or more analog signals, and further condition the analog signals to provide a modulated signal suitable for transmission over the MIMO channel. In some embodiments, the conditioning may include, but is not limited to, operations such as amplification, filtering, up-conversion and the like. The modulated signals produced by the transmitter system transceivers 222a through 222t are then transmitted from the transmitter system antennas 224a through 224t that are shown in FIG. 2.

At the receiver system 250, the transmitted modulated signals may be received by the receiver system antennas 252a through 252r, and the received signal from each of the receiver system antennas 252a through 252r is provided to a respective receiver system transceiver (RCVR) 254a through 254r. Each receiver system transceiver 254a through 254r conditions a respective received signal, digitizes the conditioned signal to provide samples and may further processes the samples to provide a corresponding “received” symbol stream. In some embodiments, the conditioning may include, but is not limited to, operations such as amplification, filtering, down-conversion and the like.

An RX data processor 260 then receives and processes the symbol streams from the receiver system transceivers 254a through 254r based on a particular receiver processing technique to provide a plurality of “detected” symbol streams. In one example, each detected symbol stream can include symbols that are estimates of the symbols transmitted for the corresponding data stream. The RX data processor 260 then, at least in part, demodulates, de-interleaves and decodes each detected symbol stream to recover the traffic data for the corresponding data stream. The processing by the RX data processor 260 may be complementary to that performed by the TX MIMO processor 220 and the TX data processor 214 at the transmitter system 210. The RX data processor 260 can additionally provide processed symbol streams to a data sink 264.

In some embodiments, a channel response estimate is generated by the RX data processor 260 and can be used to perform space/time processing at the receiver system 250, adjust power levels, change modulation rates or schemes, and/or other appropriate actions. Additionally, the RX data processor 260 can further estimate channel characteristics such as signal-to-noise (SNR) and signal-to-interference ratio (SIR) of the detected symbol streams. The RX data processor 260 can then provide estimated channel characteristics to a processor 270. In one example, the RX data processor 260 and/or the processor 270 of the receiver system 250 can further derive an estimate of the “operating” SNR for the system. The processor 270 of the receiver system 250 can also provide channel state information (CSI), which may include information regarding the communication link and/or the received data stream. This information, which may contain, for example, the operating SNR and other channel information, may be used by the transmitter system 210 (e.g., base station or eNodeB) to make proper decisions regarding, for example, the user equipment scheduling, MIMO settings, modulation and coding choices and the like. At the receiver system 250, the CSI that is produced by the processor 270 is processed by a TX data processor 238, modulated by a modulator 280, conditioned by the receiver system transceivers 254a through 254r and transmitted back to the transmitter system 210. In addition, a data source 236 at the receiver system 250 can provide additional data to be processed by the TX data processor 238.

In some embodiments, the processor 270 at the receiver system 250 may also periodically determine which pre-coding matrix to use. The processor 270 formulates a reverse link message comprising a matrix index portion and a rank value portion. The reverse link message may comprise various types of information regarding the communication link and/or the received data stream. The reverse link message is then processed by the TX data processor 238 at the receiver system 250, which may also receive traffic data for a number of data streams from the data source 236. The processed information is then modulated by a modulator 280, conditioned by one or more of the receiver system transceivers 254a through 254r, and transmitted back to the transmitter system 210.

In some embodiments of the MIMO communication system 200, the receiver system 250 is capable of receiving and processing spatially multiplexed signals. In these systems, spatial multiplexing occurs at the transmitter system 210 by multiplexing and transmitting different data streams on the transmitter system antennas 224a through 224t. This is in contrast to the use of transmit diversity schemes, where the same data stream is sent from multiple transmitter systems antennas 224a through 224t. In a MIMO communication system 200 capable of receiving and processing spatially multiplexed signals, a precode matrix is typically used at the transmitter system 210 to ensure the signals transmitted from each of the transmitter system antennas 224a through 224t are sufficiently decorrelated from each other. This decorrelation ensures that the composite signal arriving at any particular receiver system antenna 252a through 252r can be received and the individual data streams can be determined in the presence of signals carrying other data streams from other transmitter system antennas 224a through 224t.

Since the amount of cross-correlation between streams can be influenced by the environment, it is advantageous for the receiver system 250 to feed back information to the transmitter system 210 about the received signals. In these systems, both the transmitter system 210 and the receiver system 250 contain a codebook with a number of precoding matrices. Each of these precoding matrices can, in some instances, be related to an amount of cross-correlation experienced in the received signal. Since it is advantageous to send the index of a particular matrix rather than the values in the matrix, the feedback control signal sent from the receiver system 250 to the transmitter system 210 typically contains the index of a particular precoding matrix. In some instances the feedback control signal also includes a rank index which indicates to the transmitter system 210 how many independent data streams to use in spatial multiplexing.

Other embodiments of MIMO communication system 200 are configured to utilize transmit diversity schemes instead of the spatially multiplexed scheme described above. In these embodiments, the same data stream is transmitted across the transmitter system antennas 224a through 224t. In these embodiments, the data rate delivered to receiver system 250 is typically lower than spatially multiplexed MIMO communication systems 200. These embodiments provide robustness and reliability of the communication channel. In transmit diversity systems each of the signals transmitted from the transmitter system antennas 224a through 224t will experience a different interference environment (e.g., fading, reflection, multi-path phase shifts). In these embodiments, the different signal characteristics received at the receiver system antennas 252a through 254r are useful in determining the appropriate data stream. In these embodiments, the rank indicator is typically set to 1, telling the transmitter system 210 not to use spatial multiplexing.

Other embodiments may utilize a combination of spatial multiplexing and transmit diversity. For example in a MIMO communication system 200 utilizing four transmitter system antennas 224a through 224t, a first data stream may be transmitted on two of the transmitter system antennas 224a through 224t and a second data stream transmitted on remaining two transmitter system antennas 224a through 224t. In these embodiments, the rank index is set to an integer lower than the full rank of the precode matrix, indicating to the transmitter system 210 to employ a combination of spatial multiplexing and transmit diversity.

At the transmitter system 210, the modulated signals from the receiver system 250 are received by the transmitter system antennas 224a through 224t, are conditioned by the transmitter system transceivers 222a through 222t, are demodulated by a transmitter system demodulator 240, and are processed by the RX data processor 242 to extract the reserve link message transmitted by the receiver system 250. In some embodiments, the processor 230 of the transmitter system 210 then determines which pre-coding matrix to use for future forward link transmissions, and then processes the extracted message. In other embodiments, the processor 230 uses the received signal to adjust the beamforming weights for future forward link transmissions.

In other embodiments, a reported CSI can be provided to the processor 230 of the transmitter system 210 and used to determine, for example, data rates as well as coding and modulation schemes to be used for one or more data streams. The determined coding and modulation schemes can then be provided to one or more transmitter system transceivers 222a through 222t at the transmitter system 210 for quantization and/or use in later transmissions to the receiver system 250. Additionally and/or alternatively, the reported CSI can be used by the processor 230 of the transmitter system 210 to generate various controls for the TX data processor 214 and the TX MIMO processor 220. In one example, the CSI and/or other information processed by the RX data processor 242 of the transmitter system 210 can be provided to a data sink 244. In some embodiments, the processor 230 of the transmitter system 210 may be coupled with a Backhaul Interface 235. The Backhaul Interface 235 may be configured to communicate over a backhaul link (not shown) with other transmitter systems which may be embodied in one or more network nodes (e.g., access points, cells or eNBs).

In some embodiments, the processor 230 at the transmitter system 210 and the processor 270 at the receiver system 250 may direct operations at their respective systems. Additionally, a memory 232 at the transmitter system 210 and a memory 272 at the receiver system 250 can provide storage for program codes and data used by the transmitter system processor 230 and the receiver system processor 270, respectively. Further, at the receiver system 250, various processing techniques can be used to process the N_{R} received signals to detect the N_{T} transmitted symbol streams. These receiver processing techniques can include spatial and space-time receiver processing techniques, which can include equalization techniques, “successive nulling/equalization and interference cancellation” receiver processing techniques, and/or “successive interference cancellation” or “successive cancellation” receiver processing techniques.

As noted above, Downlink Cooperative Multi-Point (CoMP) transmission is proposed for LTE Advanced cellular networks. Downlink CoMP employs cooperative transmission from multiple network nodes (access points, cells or eNBs) to user equipment (UE) or multiple UEs so that inter-node interference is minimized and/or channel gain from multiple nodes is combined at the UE receiver to maximize useable power. As discussed herein, CoMP implementations can involve over-the-backhaul (OTB) interactions between nodes and methods for selecting particular sets or subsets of nodes based on uplink/downlink signal quality and limits on network complexity and over-the-air signaling overhead. Several types of information may be exchanged among nodes including, for example, channel state information (CSI) of some UEs in the system, scheduling decisions, coordination requests, beamforming vectors and data.

In one embodiment of CoMP, each UE in a network may regularly estimate short-term channels from a set of network nodes, referred to herein as the UE's radio reporting set (RRS), which includes the UE's anchor node (the node on which the UE is “camped,” in terms of LTE Rel-8 terminology) and a subset of interfering nodes subject to certain cost/benefit selection criteria (described in greater detail below). After suitable quantization (e.g., to limit uplink reporting overhead), those channels may be periodically reported to the anchor node as CSI or other channel information. The reported channel information may then be propagated to other nodes in the network over backhaul connections among the nodes. After suitable information pruning to remove redundant and/or low value information (described in greater detail below), each node in the network may select a set of other nodes, referred to herein as the node's backhaul reporting set (BRS) and defined with respect to each of its anchored UEs, to support coherent CoMP transmission.

### Construction of the Radio Reporting Sets

In one embodiment of CoMP, a preliminary operation for a candidate UE is the selection of a radio reporting set (RRS). For any given UE, periodically reporting channel information from all measurable nodes in its vicinity would require significant uplink overhead. As described herein, the UE can select a subset of the measurable nodes to be reported, corresponding to the serving cell and a limited set of dominant interferers based, for example, on a utility measure that balances the benefit of including the node (in terms of increased gain associated with a CoMP transmission and/or decreased interference) against the cost on including the node (in terms of increased channel reporting overhead).

An exemplary RRS construction method described herein can be explained in terms of a simplifying assumption that the underlying CoMP technique is linear and is able to remove all interferers reported by the UE if the channel estimation and feedback provided by the UE is perfect. It will be appreciated that such assumptions can simplify the analysis of complex or nonlinear systems and may provide useful results with a reduced computational burden.

To illustrate the exemplary method, the UE can be viewed as having one virtual receiving antenna, irrespective of the actual number of antennas at the UE, where the complex channel coefficients from all the antennas of each considered node are collected in one vector, and that vector is fed back to the anchor node. This vector, assumed to have an average energy equal to the long-term signal power from a considered node to the UE (denoted as C_{n,u}, n being a node index and u being a UE index), is obtained by assuming a specific receiver vector at the UE (e.g., an eigenvector associated with the maximum eigenvalue of the overall channel matrix from the anchor node to the UE). Where multi-stream transmission is considered (e.g., single user MIMO), two or more channel vectors are obtained, assuming different receiver vectors, and are feed back to the anchor node.

For a given time-frequency transmission resource (e.g., frame, subframe or slot), let h_{n,u}, and ĥ_{n,u} represent the channel between node n and user equipment u and the estimate of the channel, respectively. Then \sqrt{C_{n,u}}ĥ_{n,u} denotes the complex channel from node n to user equipment u (a vector of length N_{TX}, where N_{TX} is the number of transmit antennas) and \sqrt{C_{n,u}}ĥ_{n,u} denotes the corresponding estimate at the serving node. The estimate will differ from the real channel due to several impairments. There will be a channel estimation error with a variance depending on the carrier-to-interference ratio between node n and user equipment u, denoted as

$${( \frac{C}{I} )}_{n , u} .$$

There will be errors under the control of the UE or the network as a tradeoff against reporting overhead. There may be an error due to frequency reporting granularity, stemming from the fact that a single report may be generated for a set of two or more consecutive subcarriers, or resource blocks (RBs), or groups of RBs or the like in order to reduce the number of reports (hence the UL overhead). The single report for a given bandwidth may be generated, for example, by sampling, averaging, or the like. The number of reports per unit bandwidth across the entire system bandwidth may be denoted as [symbol] (note that if the UE is scheduled only on a predefined and constant or slowly varying portion of the available bandwidth, only channel coefficients belonging to the pre-assigned bandwidth would be fed back). Similarly, there may be an error due to time reporting granularity, stemming from the fact that reports are periodic and, between two consecutive reports, channels may have changed. The number of reports per second may be denoted as [symbol] . Finally, since channel vectors must be suitably quantized before being reported, an additional error due to such quantization may arise, which depends on the quantization methods and the number of bits (payload) devoted to each report, denoted as [symbol] in the following. Finally, impairments outside the control of the UE and possibly of the network, such as scheduling delays and other delays not related to the reporting period, may contribute to the estimation error.

As one example, assume a linear CoMP technique which is able to perfectly null interference from all reported channels separately, and a same transmission power for all nodes. Also, let w represent the precoding vector(s) at node n (where w is a unitary-norm column vector of length N_{TX}). Under the assumption of perfect nulling, [symbol] . The leakage interference power from node n to user equipment u is given by:

I_{n,u}=C_{n,u}E|h_{n,u}Vx|²=C_{n,u}α_{n,u}

where V is the orthogonal subspace of [symbol] (a unitary matrix of size N_{TX} by N_{TX}−1), the expectation E is with respect to the real and estimated channels and to the (N_{TX}−1)-sized column vector x (assumed to have a unitary norm with a uniformly distributed direction) and [symbol] is denoted as the rejection factor. The rejection factor [symbol] is zero if and only if [symbol] , and is upper bounded by 1. The rejection factor [symbol] is a function of the impairments identified above. That is,

$${α}_{n , u} = F ( {( \frac{C}{I} )}_{n , u} , {f}_{n , u} , {t}_{n , u} , {b}_{n , u} )$$

and depends on the quantization algorithm (e.g., separated CQI/PMI feedback or explicit channel feedback) and the use of lossy feedback compression techniques that take advantage of the correlation among adjacent (in frequency and/or time) reports to reduce the payload size, etc. Because either the UE or the network measures (C/I) and selects the values of the parameters f, t and b as well as the quantization technique, the value of the rejection factor can be predicted by the UE. In the following discussion, operations are described as being carried out by the UE. It will be appreciated that in other embodiments, some or all of the operations may be carried out at the eNodeB. In one embodiment, the UE may store values of the rejection factor, as a function of the carrier-to-interference ratio, for each set of allowed values of the parameters f_{n,u} t_{n,u} and b_{n,u} (e.g., by sampling and storing in a look-up table, or through interpolation using pre-defined functions described by a small set of stored parameters). The corresponding values of the rejection factor can be evaluated through offline computer simulations by suitably modeling all the impairments, for all values of interest of the parameters. It is assumed that the optimization of the feedback parameters, either joint or separate, as a function of the carrier-to-interference ratio and the maximum allowed degradation, are chosen by the UE according to some well-known optimization algorithm.

A further set of coefficients can be defined by analyzing the useful received power. If it is assumed that the precoding vectors at each node are designed to maximize the useful received power at the UE, then by maximum ratio combining, the useful power contributed by node n to UE u is given by:

$${C}_{n , u} E \{ \frac{{\vert {\underline{h}}_{n , u} {\hat{\underline{h}}}_{n , u}^{H} \vert}^{2}}{{‖ {\underline{\hat{h}}}_{n , u} ‖}^{2}} \} = {C}_{n , u} {β}_{n , u}$$

where the gain factor β_{n,u} has a value between 0 and 1, depends on the same parameters as the rejection factor α_{n,u} and can be pre-calculated (e.g., through computer simulations) and stored in a similar way.

As noted above, the UE can select its RRS from the set of nodes in its measurement set (MS). The MS of a UE is defined as the set of nodes for which main synchronization sequences and/or other synchronization/reference signals can be decoded successfully by the UE. In one aspect, the RRS is a subset of the measurement set for which the UE reports short-term channel coefficients over-the-air to its anchor node for CoMP purposes. Denoting Q as the number of nodes to be reported (including the anchor node (which is identified by an index n=1 below)), the overall interference at the UE u can be approximated as:

$${I}_{u }^{( Q )} = 1 + \text{?} {α}_{n , u} {C}_{n , u} + {C}_{n , u}$$

$$\text{?} \text{indicates text missing or illegible when filed}$$

where Q>0 and 1 represents a suitably normalized background (thermal) noise power. Note that interference from the Q−1 non-anchor nodes within the RRS is determined by the rejection factors α_{n,u} for those nodes, while the interference from nodes outside the RRS (n>Q) is uncontrolled. Similarly, the overall useful received power at the UE is given by:

$${C}_{u}^{( Q )} = {\sum }_{n = 1}^{Q} {β}_{n , u} {C}_{n , u}$$

The useful received power above is an upper bound, and can be too optimistic depending on the CoMP technique employed and the number of transmit antennas. If the UE implements receiver power scaling estimation and tracking, the corresponding factor can be used to scale down long-term estimated received power. In this case, RRS construction and received power scaling estimation are mutually dependent. One solution is for the UE to make an initial assumption of the scaling factor (e.g., equal to 0 dB), build the RRS, and update the RRS once a reliable estimate of the scaling factor is available. Alternatively, the upper bound above can be used as is, or it can be scaled by a constant predefined factor.

For each value Q, the UE can predict the achievable downlink rate (R) and the corresponding feedback overhead (B) in bits per second, according to

$${R}_{u}^{( Q )} = ϕ ( \frac{{C}_{u}^{( Q )}}{{I}_{u}^{( Q )}} )$$

$${B}_{u}^{( Q )} = {\sum }_{n = 1}^{Q} {t}_{n , u} {f}_{n , u} {b}_{n , u}$$

where [symbol] is a constrained capacity function. The design parameter Q trades feedback overhead with downlink spectral efficiency. The actual working point within this tradeoff curve is determined by the UE, and the choice might be based on upper layer considerations, too, such as the relative sizes of the downlink and uplink buffers, the type of uplink and downlink traffic, available uplink capacity and other aspects. The order in which the UE selects candidate nodes for the RRS may be based on a metric such as rank order of average received power from each node in the MS or rank order of carrier-to-interference ratio for each node in the MS, for example.

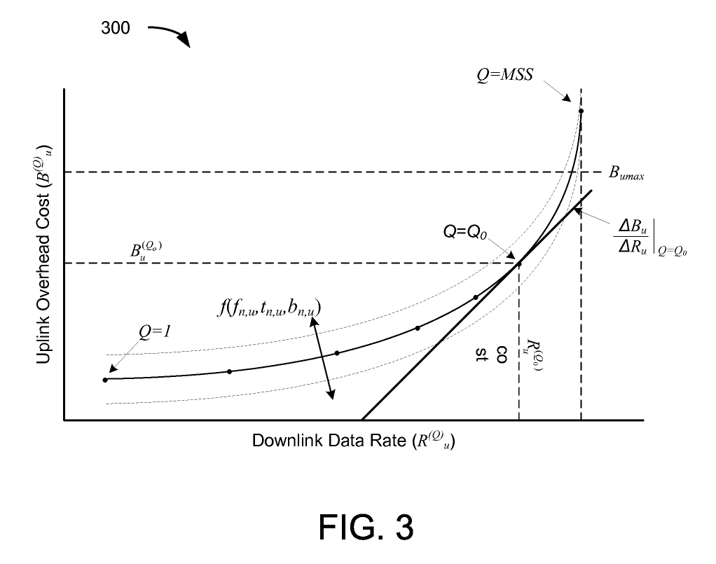

FIG. 3 is a graph 300 illustrating the relationships among the parameters discussed above. In FIG. 3, the vertical scale is uplink overhead cost in bits-per-second (BPS) as a function of Q, and the horizontal scale is the combined downlink data rate in BPS as a function of Q. Bᵤₘₐₓ is the maximum uplink overhead bit rate that the UE will accept, and Bᵤ^{(Q}^{ₒ}⁾ and Rᵤ^{(Q}^{₀}⁾ are the uplink overhead cost and downlink data rate, respectively, at the working point Q₀.

In one embodiment, the particular working curve for a UE is determined by the selection of the time/frequency and payload parameters, as illustrated by the dotted lines 301 and 302 in FIG. 3, which move as a function of the granularity and payload quantization parameters f_{n,u}, and b_{n,u} and b_{n,u}. As described above, the UE can determine the working point Q₀ based on its channel measurements and stored parameter tables.

In one embodiment, rather than assuming that all parameters related to feedback (e.g., time/frequency granularities and payload) have been optimized and the RRS designed correspondingly, the UE can use a joint optimization method. This method may be summarized as follows:
1) Fix Q and all parameters related to quantization to their maximum values (Q=measurement set size, MSS), for all nodes in the measurement set. This is the first point in a tradeoff curve (largest possible rate and feedback overhead where Q=MSS in FIG. 3);
2) Among all 1+3Q optimization variables, select one variable such that reducing that variable by one basic unit (e.g., going from a 10 resource block granularity to a 25 resource block granularity, or from 100 reports/second to 50 reports/second, etc.) maximizes the value of a utility metric that is an increasing function of downlink data rate increase and feedback overhead decrease. Examples of such a utility metric could be the ratio of feedback overhead decrease and downlink rate decrease (|ΔB/ΔR|) or a (e.g., weighted) difference between a downlink rate increase and the feedback overhead increase (|ΔB-ΔR|). In addition, this function could depend on traffic considerations (e.g., DL/UL asymmetry of imposed traffic, or QoS (quality of service) classes of DL/UL traffic, etc.);
3) Repeat step (2) until the desired working point is obtained. The working point may be defined, for example, by a feedback overhead limit or a maximum downlink data rate reduction.

The overall number of iterations required to achieve the target working point may be large (depending on the granularity of the variables), but the iteration needs to be carried out only once. If one of the parameters changes (e.g., one of the C/Is or the nodes of measurement set), the UE can increase all variables by one unit and the process can be restarted from that point. Alternatively, step (2) may be replaced by a similar operation, where one variable is increased with the objective of maximizing the ratio between downlink rate increase and uplink overhead increase.

Also, the UE may use a joint optimization algorithm similar to the one described above to automatically control the size of the radio reporting set within the maximum value determined by its measurement set. An optimum set of parameters that contains zero values for any of the parameters [symbol] yields no reporting of the corresponding nodes within UE's measurement set.

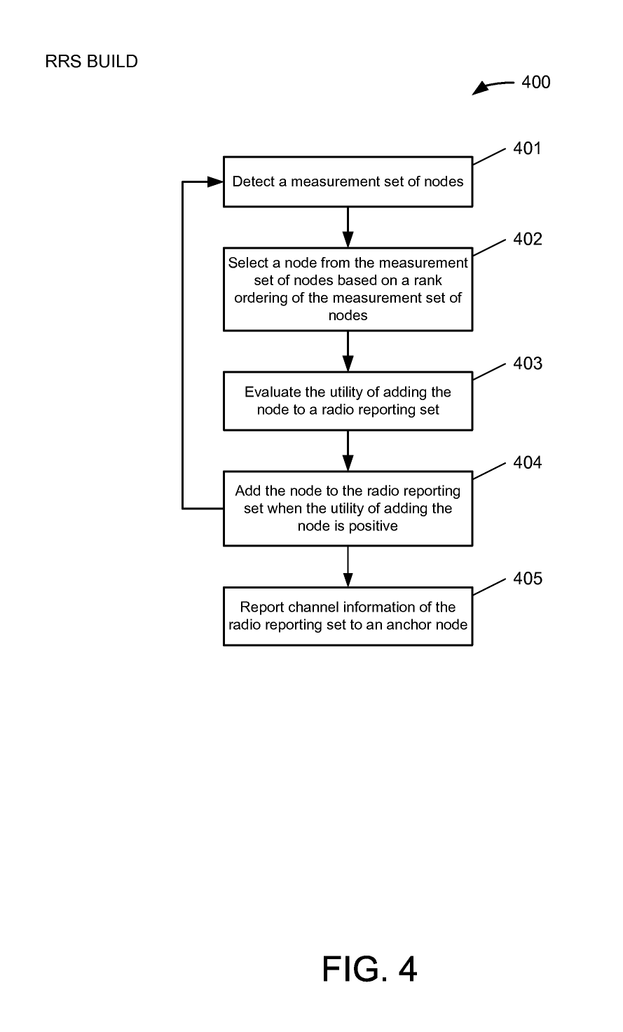

FIG. 4 is a flowchart 400 illustrating an exemplary method for the construction of a radio reporting set by a user equipment. The method begins at operation 401, where the UE detects a measurement set of nodes, comprising the UE's anchor node and those nodes whose broadcast synchronization signals have been successfully acquired by the UE. Next, at operation 402, the UE selects a node from the measurement set for inclusion in the radio reporting set (RRS) based on a rank ordering of the measurement set of nodes (e.g., based on signal strength, C/I, etc.). At operation 402, the method continues by evaluating the utility of adding the node to a radio reporting set (e.g., based on estimated values of downlink data rate and uplink reporting overhead). At operation 403, the node is added to the radio reporting set when the utility of adding the node is positive (e.g., an increase in downlink data rate for a CoMP transmission exceeds an increase in uplink overhead). Operations 401-404 may be repeated until the utility of adding another node to the radio reporting set is no longer positive. Then, at operation 405, the UE reports channel information of the radio reporting set to the anchor node of the UE. If the UE detects changes in the measurement set of nodes or the radio reporting set (e.g., due to movement of the UE or channel fading), it may reconstruct the radio reporting set starting from scratch or by retaining existing members of the radio reporting set and evaluating the utility of adding nodes from the present measurement set.

### Construction of the Backhaul Reporting Set

Each UE in a CoMP capable network may establish its RRS as described above and report the CSI to its anchor node periodically. To support CoMP, that information may be communicated to other nodes in the network over the backhaul. However, in some cases, the CSI cannot be exchanged among all nodes in the network due to complexity considerations. Additionally, there may be no utility in sharing information beyond certain boundaries because the corresponding over-the-air signals may be attenuated too much by distance to provide a benefit that exceeds the overhead cost of reporting the information.

A suitable set of limited size, denoted as the backhaul reporting set (BRS), may be constructed by each anchor node, from which the anchor node may select a subset for participation in a coherent CoMP transmission. That subset is referred to herein as the transmission set (TS). Since the configuration of any network is dynamic (e.g., UEs enter or leave the network and move within the network), information exchange between nodes of the BRS may be frequent, and it may be assumed that a persistent connection is maintained between nodes of the BRS, although not necessarily so. Both the maximum BRS size (BRSS) and the way the BRS is built are considered because there will be a tradeoff between the number of open backhaul connections between nodes (which increases the complexity of the network topology, cost, latency, eNB router capability, etc.) and the overall performance of the CoMP scheme (e.g., increases in useful received power and reduction of inter-node interference, which translates to higher data throughput).

Membership in the BRS of a node is defined herein as follows. Node m belongs to the BRS of node n if and only if node m can send CoMP-related information to node n (e.g., CSI for UEs associated with nodes m). As defined, BRS membership can be “asymmetric.” That is, if m belongs to the BRS of n, n does not automatically belong to the BRS of m. However, for any specific network deployment, if replacing an existing simplex connection between two nodes with a duplex connection does not entail any significant cost and/or complexity increase, then it can be assumed that all connections are duplex and that BRS membership is symmetrical without loss of generality. In the following description, the more general “asymmetric” definition of BRS will be assumed.

As mentioned above, effective construction of the BRS for each node is considered due to the complexity/performance tradeoff. The simplest approach for designing a BRS is based on geographical considerations. If the network deployment is regular enough (e.g., hexagonal cell deployment), the BRS could be built based only on distance considerations. That is, node m is in the BRS of node n if and only if the geometrical distance between those two nodes is below a given threshold. If the two nodes m and n are far apart, coordination between those nodes does not yield very much benefit in terms of performance. This approach to defining the BRS results in a BRS that is static, changing only when new nodes are added to the network that satisfy the geographical constraints.

Although simple, a solely geometric approach may have several drawbacks. Its effectiveness in practical deployments that are geographically irregular may be limited. The geometric approach does not take into account network topology. For example, even if two nodes are geometrically close, maintaining an open connection between them might be expensive because of the presence of weak links or routers in the backhaul network (e.g., a logical connection between nodes, represented as a direct link, may actually take a circuitous route through the backhaul network). Also, the geometric approach does not necessarily account for UEs with positions in the network, and corresponding long-term channels, that would control the performance of the CoMP if their corresponding nodes were in the BRS. For example, although two nodes may be very close, if no UEs are in the handover region of these two nodes the benefit of cooperation between the two nodes may be negligible.

In one aspect, long-term channels and interference levels of UEs associated with distant nodes may be used to build the BRS. Part of this information resides at anchor nodes throughout the network as a result of the RRS construction process described above. Other salient information includes information at these nodes on other associated UEs such as their carrier to interference (C/I) ratios toward all the nodes in their respective RRSs, etc. This information is referred to hereafter as the “BRS build information.” In one embodiment, this information may flow through the network according to a “flooding algorithm”, with an upper cap on the number of hops between nodes over which the information is propagated.

In one embodiment of a flooding algorithm, each node in the network serving one or more UEs (“reference nodes” in this description for clarity) receives information from its adjacent nodes (1^{st} tier adjacent nodes) about the UEs associated with the adjacent nodes, as well as information the 1^{st} tier adjacent nodes have received from their adjacent nodes (2^{nd} tier adjacent nodes relative to the reference nodes). As used herein, two nodes are “adjacent” if there exists at least one UE that has both nodes in its radio reporting set. The information received at the reference nodes from the 1st tier adjacent nodes may include tags that identify the number of hops traveled so far by the information provided. For example, information that originates at the 1^{st} tier adjacent nodes would be tagged as “1-hop” information, while information that originated from the 2^{nd} tier adjacent nodes would be tagged as “2-hop” information. In this way, each node may determine the relevance of the information it receives. It will be appreciated that a node may receive redundant information. There may be two or more different paths between any pair of nodes reporting the same information from a sourcing node. Therefore, each node may be configured to remove such redundant information before it appends information regarding its own associated UEs. It may then append its own information and increase the “number of hops” tag before it forwards the information to its adjacent nodes. The node may apply a predetermined rule such as, for example, “discard information from nodes that are more than two (or some other number) hops away.” In this way, each node is kept informed about UEs with nodes up to a given number of hops away, where the maximum number of hops is a design parameter.

Flooding may be viewed as waves of information flowing away from each node in the network toward other nodes, with a limit on the distance traveled (in terms of number of hops between nodes). The removal of redundant information may be viewed as destructive interference of the propagating waves of information, while appending local information may be viewed as constructive interference of the propagating waves of information.

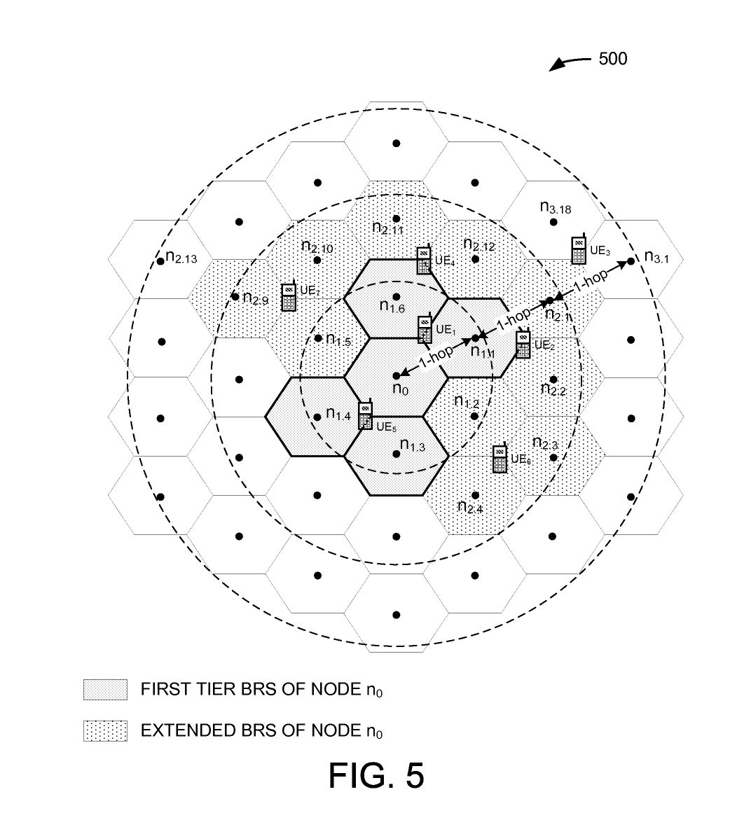

FIG. 5 illustrates a simplified example of the flooding algorithm for the case of a regular deployment of nodes (e.g., hexagonal), where the nodes are numbered according to their relationship to a central node (node n₀). That is, the first tier of nodes is numbered n_{1.1}-n_{1.6}, the second tier of nodes is numbered n_{2.1}-n_{2.12}, etc. Note that nodes in these tiers are not necessarily “adjacent” unless they share one or more UEs in common. For purposes of the present discussion, assume the following exemplary configuration:
UE₁ is anchored to node n₀ and the RRS of UE₁ includes nodes n₀, n_{1.1}, n_{1.2} and n_{1.6}
UE₂ is anchored to node n_{1.1} and the RRS of UE₂ includes nodes n_{1.1}, n_{2.1} and n_{2.2}
UE₃ is anchored to node n_{3.1} and the RRS of UE₃ includes nodes n_{2.1}, n_{3.1} and n_{3.18}
UE₄ is anchored to node n_{1.6} and the RRS of UE₄ includes nodes n_{1.6}, n_{2.11} and n_{2.12}
UE₅ is anchored to node n₀ and the RRS of UE5 includes nodes n₀, n_{1.3}, n_{1.4} and n_{1.5}

In this example, under the definition of “adjacent nodes” given above, nodes n_{1.1}, n_{1.2}, n_{1.3}, n_{1.4} and n_{1.6} are adjacent to node n₀, nodes n_{2.1} and n_{2.2} are adjacent to node n_{1.1}, and nodes n_{3.1} and n_{3.18} are adjacent to node n_{2.1}. If the propagation of information is limited to two hops, for example, then information about the RRS of UE₁ will flow from node n₀ to nodes n_{1.1} and n_{2.1}, but not to node n_{3.1}. Similarly, information about the RRS of UE₃ will flow from node n_{3.1} to nodes n_{2.1} and n_{1.1}, but not to node n₀. Information about the RRS of UE₂ will flow from node n_{1.1} to nodes n₀, n_{2.1} and n_{3.1}. Note also, that information from node n₀ may reach node n_{1.1} directly, or via a path through node n_{1.6}. As described above, node n_{1.1} may be configured to recognize the redundant information and remove the redundancy before it forwards the information to its adjacent nodes.

Once the BRS build information is propagated through the network, each node may initiate the selection of its individual backhaul reporting set. A BRS selection method should be adaptive, such that nodes may be added or removed from the BRS of each node in response to channel or system variations (e.g., different long-term received powers or interference to specific UEs, UEs joining or quitting the system, etc.). These classes of events have relatively long timeframes compared to the typical time frames required for wireless data transfer, and therefore the periodicity of information exchange OTB that is required to keep the BRS updated can be on the order of hundreds of milliseconds or more.

Nodes may use information regarding the topology of the network and the quality of the backhaul links for BRS construction, if available. Let the real number w_{n,m} denote the “cost” of having node m in the BRS of node n (e.g., an amount of resources utilized to support an open connection between m and n). This value may be a function of the number of hops, estimated latency, maximum throughput, etc. of that specific link. The tradeoff between performance improvement (due to coordination) and overhead cost will be taken into account by the BRS construction method when making the decision to add a specific node to the BRS.

In one embodiment, nodes may perform BRS construction by exchanging messages, where those messages include, among other information, the useful received power and interference values for several UEs. Notwithstanding that the rate of information exchange is small for each UE, the total amount of information exchange could be large because data associated with several UEs is exchanged. Accordingly, a UE pruning algorithm may utilized, such that each node selects a subset of associated UEs and exchanges information for only those UEs. UE selection may be based upon the expected performance improvements that each UE can achieve when coordination is assumed. In this way, only UEs in the handoff region of a node will be selected, whereas noise limited UEs might be ignored and their powers and interference values not exchanged for the sake of complexity reduction.

The BRS construction method may be carried out independently at each node. As noted with respect to the RRS construction described above, a simplifying assumption may be made that interference from all nodes inside the RRS of each UE is perfectly canceled. Although some CoMP algorithms may approach this level of cancellation in some scenarios, in general this might be an optimistic assumption. Moreover, for simplicity, link costs are not considered when deciding which node to append (i.e., all links are assumed to have the same relative weight). Finally, in a sectorized network deployment, it may be assumed that all sectors (including remote radio heads) belonging to the same node always communicate, because the cost of communication among those devices is negligible. In the exemplary embodiment described below, the term “central node” describes the node that is evaluating its own BRS (where each node does this processing in parallel).

An initial BRS construction accounts for UEs associated with the central node only (i.e., UEs that may be victims of interference from the central node are not taken into account). All UEs anchored to the central node are considered. For example, taking node n₀ as the central node in FIG. 5, there are two UEs anchored to the central node (UE₁ and UE₅). The signal-to-interference plus noise ratio (SINR) is evaluated for all those UEs (recall that this information is reported to the anchor node as part of the RRS reporting process) and the maximum achievable data rates can be evaluated assuming maximum ratio combining (MRC) beamforming from the central node and long-term interference from nodes outside of the RRS. The upper bound SINRs can be evaluated for the same UEs, assuming MRC from all nodes in the RRS of each UE, and the same interference from nodes outside the RRS and the corresponding upper bound achievable data rates are evaluated.

In order to have interference nulling for a node in the RRS of a given UE, that node must also be in the BRS of the anchor node of the UE. Hence, for each UE associated to the central node that may benefit from CoMP, all or some of the nodes in its RRS may be added to the BRS of the anchor node. For each UE associated with the central node, nodes in its RRS may be appended to the BRS until the corresponding achievable data rate is close enough to the upper bound. A relative threshold can be defined for this operation, such as a certain percentage of the maximum achievable rate.

After these first steps, there is an initial or first tier BRS that accounts for served UEs only. In FIG. 5, for example, the first tier BRS of node n₀ may include the RRSs of both UE₁ and UE₅ (i.e., nodes n1.1, n1.3, n1.4 and n1.6). If the first tier BRS built according to this rule is larger than a maximum allowed BRS size determined, for example, by absolute complexity limits or by design rules, the node may repeat the same procedure but with a lower performance threshold until the initial BRS size is smaller than the maximum size.

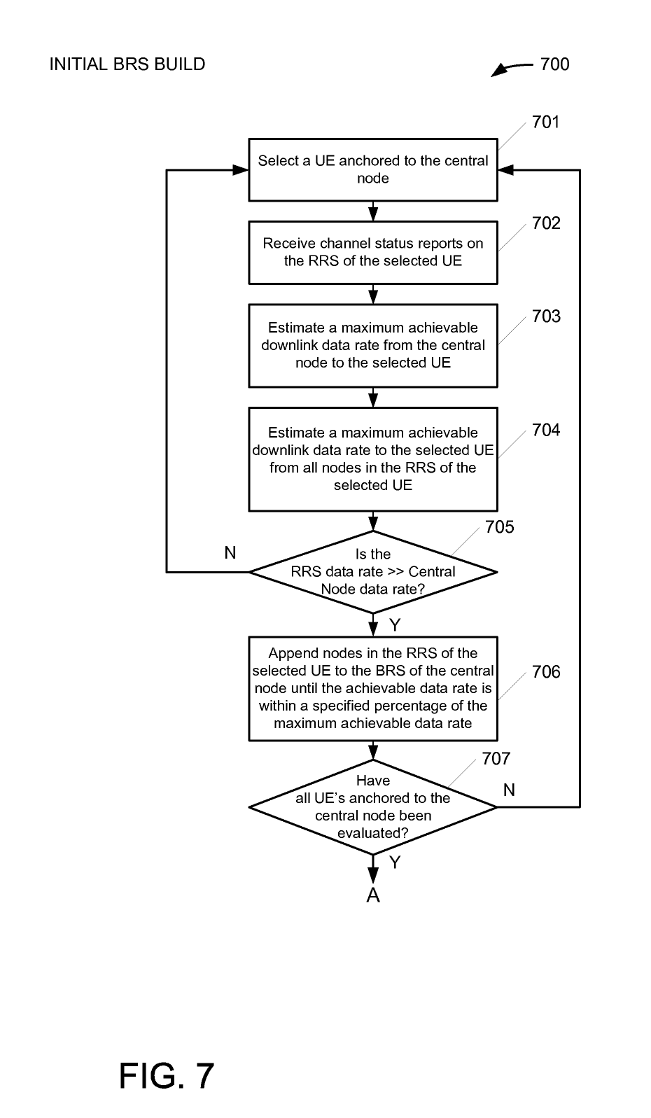

FIG. 7 is a flowchart 700 illustrating an exemplary construction of the first tier of a BRS that may be performed, for example, by a central node. In operation 701, a central node selects a UE anchored to the central node, and at operation 702, the central node receives from the selected UE channel status reports for the nodes in its RRS. At operation 703, the central node estimates the maximum achievable data rate that can be provided to the UE by the central node alone (“central node data rate”). At operation 704, the central node estimates the maximum achievable data rate that can be provided to the UE by all of the nodes in the RRS of the UE (“RRS data rate”). In operation 705, the central node determines if the RRS data rate exceeds the central node data rate by some predetermined margin. If the margin is not significant, then the central node selects another UE (operation 701) and repeats operations 702-704. If the margin is significant, then at operation 706, the central node appends nodes in the RRS of the selected UE to the BRS of the central node until the estimated achievable data rate to the UE from the appended nodes is within a specified percentage of the maximum achievable rate estimated at operation 704. This process continues until all UEs anchored to the central node have been evaluated (operation 707), whereupon the central node can proceed to build an extended BRS as described below.

An extended BRS (extBRS), or 2nd tier BRS, may be defined as the union of all nodes adjacent to at least one of the 1^{st} tier nodes currently in the BRS. In FIG. 5, for example, the extended BRS of node n₀ may include nodes n_{2.11} and n_{2.12} (adjacent to node n_{1.6}) and n_{2.1} and n_{2.2} (adjacent to node n1.1). For each node in the extBRS, one or more UEs (victim UEs) among those reported, can be randomly chosen (mimicking conventional random access scheduling). Then, fading channels between all nodes in the BRS and all scheduled UEs are randomly generated according to an independent and identically distributed (IID) Rayleigh model, in accordance with available long-term received power information.

Beam selection is performed with the aim of finding one precoding vector (of size NTx by the number of nodes within the BRS) for each scheduled UE associated with the central node.

The generation of fading channels and beam selection are repeated for a given number of iterations. The precoding vectors obtained at each iteration can be used to estimate the transmit power of all nodes in the BRS, the useful received power of all UEs associated with the central node and the leakage interference power to all UEs within the extBRS.

In one aspect, two candidate nodes for the BRS may be chosen according to the following procedure, based on a maximum signal condition and a minimum interference condition, respectively.

First, estimate the achievable information rate for each UE associated with the central node, using the estimated received power and the information rate achievable by the UEs assuming full MRC received power using the long-term information of all nodes within the RRS of each UE. Second, select the UE with the lowest data rate (i.e., largest performance gap) with respect to the ideal rate. The first candidate node can be identified as the strongest node of that UE which is not yet in the BRS. This is the maximum signal candidate node. If all the nodes in the RRS of that UE are in the BRS, the UE with the next largest relative gap can be selected, and so on. Referring again to FIG. 5, and the BRS of node n₀, for example, assume that between UE₁ and UE₅, UE₅ has the largest performance gap. Node n_{1.5} is in the RRS of UE₅, but not yet in the BRS of node n₀. Therefore, node n₀ could add node n_{1.5} to its BRS because node n_{1.5} would be the strongest node (the only node in this example) in the RRS of UE₅ that is not already in the BRS of node n₀.

Next, for each UE associated with any node in the current extBRS, the central node can evaluate the ratio between the estimated interference (which depends on the current BRS) and the long-term interference obtained by assuming that nodes in the RRS of that UE don't contribute any interference. Next, the central node can pick the UE with the largest ratio between the two estimated interference values—that is, the UE for which the ratio between the currently estimated interference and the most optimistic value is the largest. The candidate node is the dominant node for that UE, not yet in the BRS of the central node. If all nodes in the RRS of that UE are in the BRS, check the second UE, and so on. In FIG. 5, for example, assume that node n_{1.2} is the dominant node (i.e., has a larger influence on interference than node n_{1.5}) and is therefore selected as the minimum interference candidate.

Between the two candidates, the actual node to append to the BRS of the central node may be chosen according to a heuristic rule. For example, predicted rate increases for the two target UEs, obtained by adding the corresponding target nodes to the BRS, may be compared. If there are no maximum signal candidates (e.g., because all potential candidates are already in the BRS), then the central node may stop the procedure. Otherwise, if the maximum BRS size has not been exceeded, the central node can identify the next tier of the extended BRS (nodes adjacent to nodes in the current BRS) and repeat the candidate selection process.

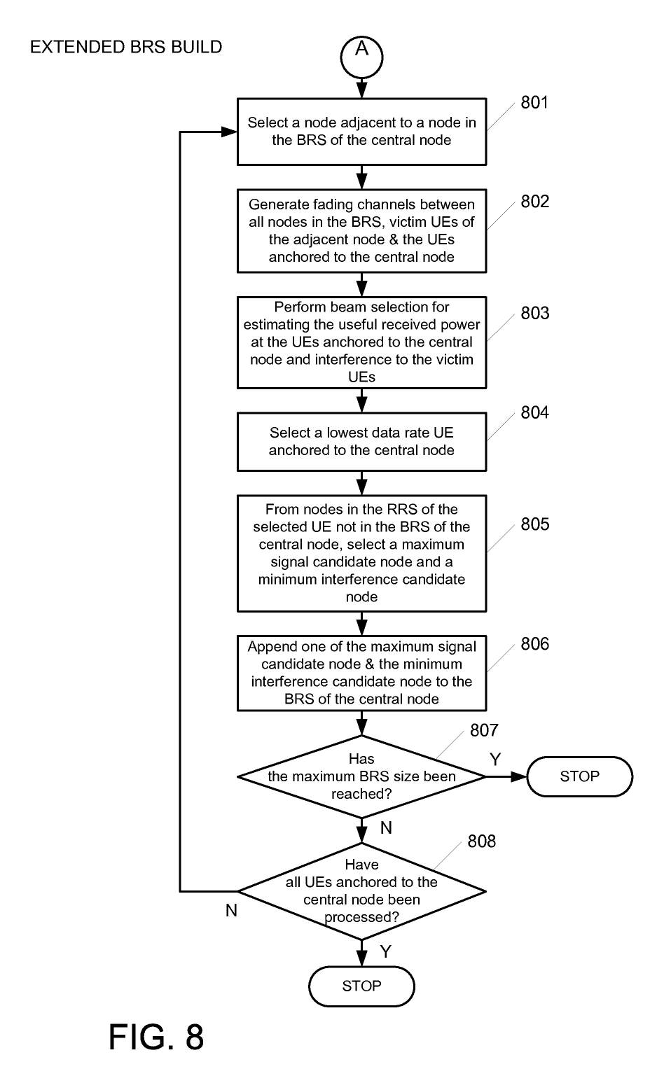

FIG. 8 is a flowchart 800 illustrating an exemplary construction of an extended BRS after the initial BRS construction illustrated in FIG. 7. At operation 801, the central node selects a node adjacent to a node in the BRS of the central node. At operation 802, the central node generates fading channels between all nodes in the BRS, victim UEs of the adjacent node and the UEs anchored to the central node. At operation 803, the central node performs beam selection for estimating the useful received power at the UEs anchored to the central node and interference to the victim UEs. At operation 804, the central node selects a lowest data rate UE anchored to the central node. At operation 805, from nodes in the RRS of the selected UE not in the BRS of the central node, the central node selects a maximum signal candidate node and a minimum interference candidate node (as described above). At operation 806, the central node appends either the maximum signal candidate node or the minimum interference candidate node to the BRS of the central node, based on a rule (e.g., a relative interference level). The process stops at operation 807 if the maximum BRS size has been reached. At operation 808, the process stops if all UEs anchored to the central node have been processed. Otherwise, the process continues at operation 801 where another adjacent node is selected.

Once the maximum BRS size has been reached or there are no more valid candidate nodes to append, a connection is opened between the central node and each node in the BRS, and those nodes are informed that they belong to the BRS of the considered central node so that coordination can begin. Then, for each scheduling occasion each node selects a subset of nodes from its BRS that will cooperate in the CoMP transmission to the UEs anchored to that node, for that specific transmission. These nodes are referred to herein as the transmission set (TS) of nodes and may be different for each UE anchored to the selecting node. The TS may vary on a subframe-by-subframe basis, depending on scheduling decisions, while the BRS is typically semi-static.

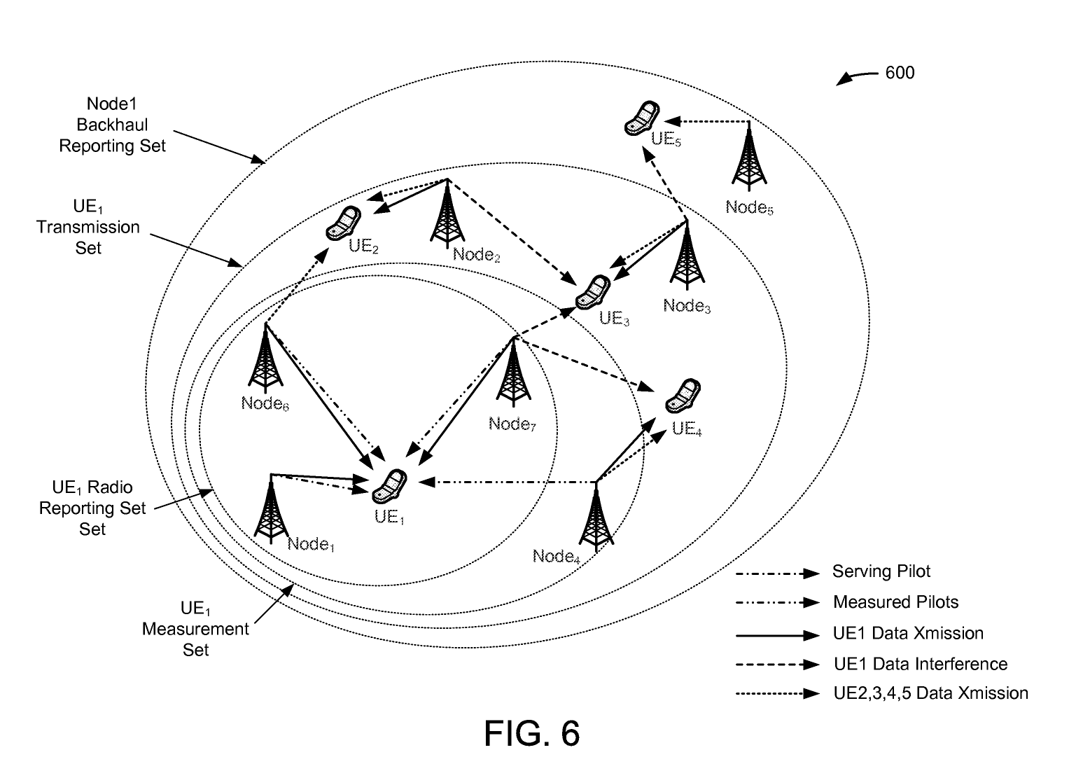

FIG. 6 illustrates an exemplary network 600, showing various interactions for CoMP transmission of data, and illustrating the various sets and parameters defined above. In particular, FIG. 6 illustrates CoMP transmission to an exemplary UE, UE1, which is anchored to an exemplary node, Node1. It is also assumed that the RRS and BRS construction processes have already taken place as described above. A similar process is carried out at the same time for transmission to all other scheduled UEs in the system, UE₂ through UE₇ for the example of FIG. 6.

In particular, for the example of FIG. 6, the BRS of Node 1 includes Node2 through Node7. The transmission set (TS) for UE₁, relative to Node1 includes Nodes 1, 2, 3, 4, 6 & 7 (Nodes is in the BRS of Node1 but not in the TS of UE₁). The measurement set (MS) of UE₁ includes Node 1, 4, 6 & 7, and the radio reporting set (RRS) of UE1 includes Nodes 1, 6 & 7. As shown, the RRS is a subset of the MS and the TS, and the TS is a subset of the BRS. However, the MS of a UE may include nodes that are outside the BRS of its anchor node.

From the point of view of Node₁, the operations illustrated in FIG. 6 may be described as follows. First, Node₁ periodically receives channel feedback reports from all its associated UEs (of which, only UE₁ is illustrated). Based on the channel reports of its associated UEs only, Node₁ selects UE₁ for scheduling, for example. Similarly, all other Nodes in the system (Node₂ through Node₇) pick their own UEs. The CSI of all scheduled UEs, and the corresponding scheduling information, are reported by Node₂ through Node₇ over the backhaul (OTB) network (not shown) to Node'. As a result, Node₁ is aware of all the channels of UE₁, UE₂, UE₃, UE₄, and UE₅, since Node₂ to Node₇ are in the BRS of Node₁. Based on the CSI and the scheduling information received in the previous step, Node₁ selects Nodes 1-4, 6 & 7 as the transmission set (TS) to be used for joint transmission of the data packet to UE₁, and the corresponding precoding vectors. The precoding vectors are communicated OTB from Node₁ to all the nodes in the TS of Node₁ (Nodes 2-4, 6 & 7). Next, the data packet for UE₁ is routed by the network to Node₁ and to all of the nodes in the TS of UE₁. This again involves OTB communications. Nodes in the TS of UE₁ transmit the data packet to UE₁ using the specified precoding vectors, along with other data packets scheduled for their associated UEs. All of the OTB interactions described above involve communications among nodes in the BRS only. In some designs, communications with a Node outside the BRS is avoided in keeping with objective to limit network complexity and communication overhead. In some scenarios, it may be advantageous to force the TS size (TSS) to 1, where only the anchor node of a UE is allowed to send a packet for the UE. This eliminates the need to exchange data over the backhaul (e.g., MAC layer PDUs). If TSS=1, CSI and scheduling information are still exchanged, but total overhead may be reduced when needed (e.g., in the presence of a weak link between nodes) or heavy data loads imposed by other transmission sets in the network.

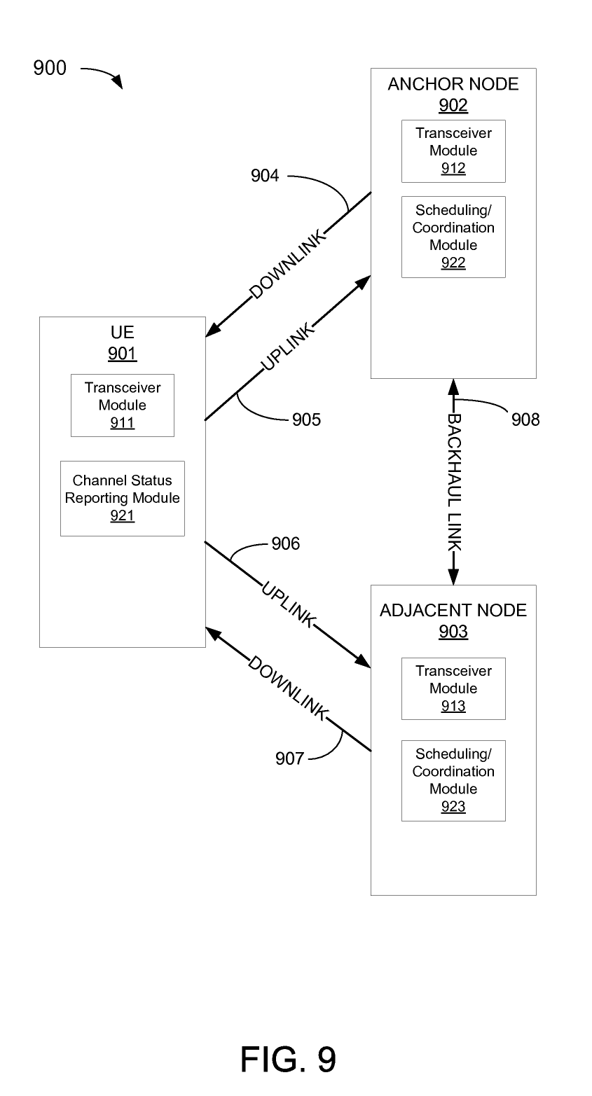

FIG. 9 illustrates a CoMP communication system 900 capable of supporting the various operations described above. System 900 includes an anchor node 902 having a transceiver module 912 that can transmit and/or receive information, signals, data, instructions, commands, bits, symbols and the like. The anchor node 902 can communicate with a user equipment (UE) 901 via a downlink 904. The anchor node 902 can also communicate with the UE 902 via an uplink 905. In particular, the anchor node 902 may be configured to receive channel status information from the UE 901. The anchor node 902 includes a scheduling/coordination module 922 for scheduling, coordinating and distributing downlink and uplink resources to the UE 901 in coordination with the adjacent node 903. The anchor node 902 can communicate with the adjacent node 903 via the backhaul link 908.

The adjacent node 903 includes a transceiver module 913 that can transmit and/or receive information, signals, data, instructions, commands, bits, symbols and the like. The adjacent node 903 can communicate with the UE 901 via a downlink 907. The adjacent node 903 can also communicate with the UE 901 via an uplink 906. The adjacent node 903 includes a scheduling/coordination module 922 for receiving and processing resource allocation, precoding vectors, beamforming information and the like from the anchor node 902.

The UE 901 includes a transceiver module 911 for communication with the anchor node 902 and the adjacent node 903 as described above. Additionally, the UE 902 includes a channel status information (CSI) reporting module 1221 that reports CSI to the anchor node 902 that can be used to determine the composition of various groups of nodes for coordinated multi-point transmissions to the UE 901 such as a backhaul reporting set and a transmission set of the anchor node 902, and a measurement set and a radio reporting set of the UE 901. Moreover, although not shown, it is contemplated that any number of anchor nodes similar to anchor node 902, any number of UEs similar to UE 901 and any number of adjacent nodes similar to adjacent node 903 can be included in system 900.

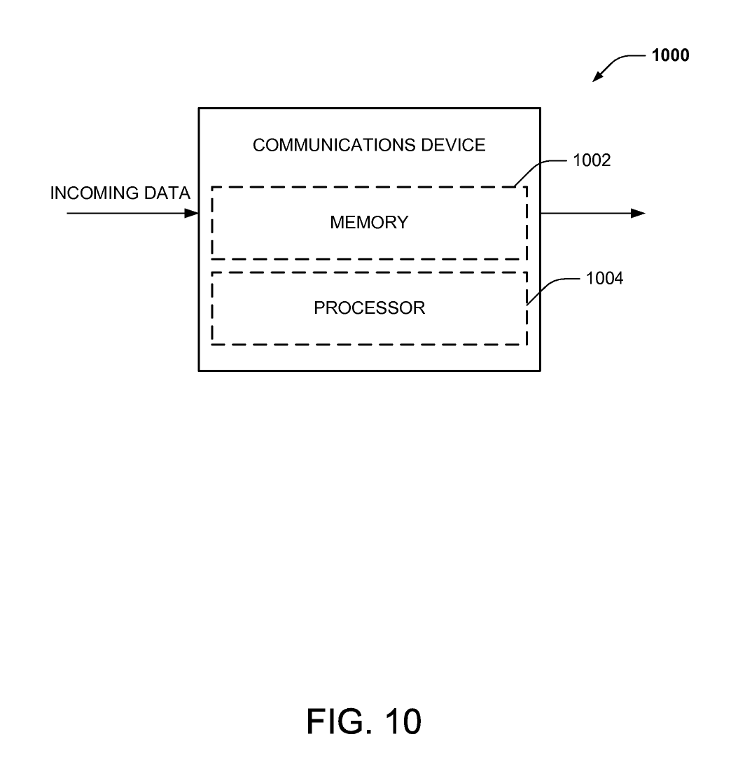

FIG. 10 illustrates an apparatus 1000 within which the various disclosed embodiments may be implemented. In particular, the apparatus 1000 that is shown in FIG. 10 may comprise at least a portion of an anchor node such as anchor node 902, at least a portion of an adjacent node such as adjacent node 903, and/or at least a portion of a user equipment such as the UE 901, and/or at least a portion of a transmitter system or a receiver system (such as the transmitter system 210 and the receiver system 250 that are depicted in FIG. 2). The apparatus 1000 that is depicted in FIG. 10 can be resident within a wireless network and receive incoming data via, for example, one or more receivers and/or the appropriate reception and decoding circuitry (e.g., antennas, transceivers, demodulators and the like). The apparatus 1000 that is depicted in FIG. 10 can also transmit outgoing data via, for example, one or more transmitters and/or the appropriate encoding and transmission circuitry (e.g., antennas, transceivers, modulators and the like). Additionally, or alternatively, the apparatus 1000 that is depicted in FIG. 10 may be resident within a wired network.

FIG. 10 further illustrates that the apparatus 1000 can include a memory 1002 that can retain instructions for performing one or more operations, such as signal conditioning, analysis and the like. Additionally, the apparatus 1000 of FIG. 10 may include a processor 1004 that can execute instructions that are stored in the memory 1002 and/or instructions that are received from another device. The instructions can relate to, for example, configuring or operating the apparatus 1000 or a related communications apparatus. It should be noted that while the memory 1002 that is depicted in FIG. 10 is shown as a single block, it may comprise two or more separate memories that constitute separate physical and/or logical units. In addition, the memory while being communicatively connected to the processor 1004, may reside fully or partially outside of the apparatus 1000. It is also to be understood that one or more components, such as the anchor node 902, the adjacent node 903 and the user equipment 901 depicted in FIG. 9 can exist within a memory such as the memory 1002.

It will be appreciated that the memories that are described in connection with the disclosed embodiments can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM) or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM) and direct Rambus RAM (DRRAM).

It should also be noted that the apparatus 1000 of FIG. 10 can be employed as a user equipment or mobile device, and can be, for instance, a module such as an SD card, a network card, a wireless network card, a computer (including laptops, desktops, personal digital assistants PDAs), mobile phones, smart phones or any other suitable terminal that can be utilized to access a network. The user equipment accesses the network by way of an access component (not shown). In one example, a connection between the user equipment and the access components may be wireless in nature, in which access components may be the base station and the user equipment is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA) or any other suitable protocol.

Access components can be an access node associated with a wired network or a wireless network. To that end, access components can be, for instance, a router, a switch and the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments. As noted above, a memory and/or a computer-readable medium may include removable and non-removable storage devices including, but not limited to, Read Only Memory (ROM), Random Access Memory (RAM), compact discs (CDs), digital versatile discs (DVD) and the like. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Generally, program modules may include routines, programs, objects, components, data structures, etc., that perform particular tasks or implement particular abstract data types. Computer-executable instructions, associated data structures and program modules represent examples of program code for executing steps of the methods disclosed herein. The particular sequence of such executable instructions or associated data structures represents examples of corresponding acts for implementing the functions described in such steps or processes.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions and so on) that perform the functions described herein. The software codes may be stored in memory units and executed by processors. The memory unit may be implemented within the processor and/or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., user equipment-to-user equipment) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed embodiments. SC-FDMA has similar performance and essentially a similar overall complexity as those of OFDMA systems. SC-FDMA signal has lower peak-to-average power ratio (PAPR) because of its inherent single carrier structure. SC-FDMA can be utilized in uplink communications where lower PAPR can benefit a user equipment in terms of transmit power efficiency.

Moreover, various aspects or features described herein may be implemented as a method, apparatus or article of manufacture using standard programming and/or engineering techniques. The term “article of manufacture” as used herein is intended to encompass a computer program accessible from any computer-readable device, carrier or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an ASIC. Additionally, the ASIC may reside in a user equipment (e.g. 1201 FIG. 12). In the alternative, the processor and the storage medium may reside as discrete components in a user equipment (e.g., 1201 FIG. 12). Additionally, in some embodiments, the steps and/or actions of a method or algorithm may reside as one or any combination or set of codes and/or instructions on a machine readable medium and/or computer readable medium, which may be incorporated into a computer program product.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A system, comprising:
an anchor node; and
a user equipment, the user equipment comprising:
a first processor configured to select a radio reporting set of nodes from a measurement set of nodes in a communication network and report channel state information for nodes in the radio reporting set to the anchor node, and
a first memory coupled to the first processor,
wherein the anchor node comprises:
a second processor configured to select a backhaul reporting set of nodes based on a measure of utility derived from the channel state information, propagate the channel state information from nodes in the radio reporting set to adjacent nodes in the communication network, and implement a cooperative multi-point (CoMP) transmission in a transmission set of nodes selected from the backhaul reporting set; and
a second memory coupled to the second processor.

2. A method, comprising:
detecting a plurality of nodes in a communication network;
selecting a subset of the plurality of nodes based on a utility of incorporating the subset in a communication group for a coordinated multi-point (CoMP) transmission; and
reporting the subset within the communication network.

3. The method of claim 2, in a user equipment,
wherein detecting the plurality of nodes comprises receiving signals from nodes in a measurement set of the user equipment, the measurement set comprising nodes in the communication network for which the user equipment is capable of performing signal measurements, and
wherein reporting the subset comprises transmitting channel status information on the subset from the user equipment to an anchor node of the user equipment, the subset comprising a radio reporting set (RRS) of the user equipment.

4. The method of claim 3, further comprising:
determining, at the UE, a downlink performance benefit to the CoMP transmission and an uplink resource cost associated with adding a first node in the measurement set of the UE to the RRS,
wherein selecting the radio reporting set comprises adding the first node to the RRS when the downlink performance benefit of adding the node exceeds the uplink resource cost of adding the node.

5. The method of claim 4, wherein the downlink performance benefit and the uplink overhead cost are weighted functions of one or more of channel capacity, channel traffic and quality of service.

6. The method of claim 3, further comprising:
determining, at the UE, a downlink performance benefit to the CoMP transmission and an uplink resource cost associated with adding a first node in the measurement set of the UE to the RRS,
wherein selecting the radio reporting set comprises selecting a node from the measurement set when a marginal increase of downlink performance benefit of adding the node exceeds a marginal increase of uplink resource cost of adding the node.

7. The method of claim 3, further comprising:
determining, at the UE, a downlink performance benefit to the CoMP transmission and an uplink resource cost associated with adding a first node in the measurement set of the UE to the RRS,
wherein selecting the radio reporting set comprises selecting a node from the measurement set when a ratio of a marginal increase in downlink performance to a marginal increase in uplink overhead resource cost is increased by adding the node.

8. The method of claim 2, in an anchor node, further comprising determining a downlink performance benefit to the CoMP transmission and an uplink overhead resource cost associated with adding a node to the communication group, wherein the downlink performance benefit comprises a measure of received power increase or a measure of interference reduction and the uplink overhead resource cost comprises a measure of signaling overhead.

9. The method of claim 8, wherein the measure of received power increase comprises a gain factor based on at least a carrier-to-interference ratio, a frequency reporting granularity, a time reporting granularity and a payload quantization parameter.

10. The method of claim 8, wherein the measure of interference reduction comprises a rejection factor based on at least a carrier-to-interference ratio, a frequency reporting granularity, a time reporting granularity and a payload quantization parameter.

11. The method of claim 2, in an anchor node, further comprising adjusting one or more of a reporting time granularity, a reporting frequency granularity and a payload size to maximize a ratio of downlink performance increase to uplink overhead decrease for the CoMP transmission.

12. The method of claim 2, in an anchor node,
wherein detecting the plurality of nodes comprises receiving communication signals over a backhaul network at the anchor node, the communication signals comprising channel status reports from adjacent nodes of the anchor node on user equipment anchored to the anchor node and user equipment anchored to the adjacent nodes, and
wherein selecting the subset comprises evaluating at the anchor node a utility of incorporating the adjacent nodes into a backhaul reporting set (BRS) of the anchor node for the coordinated multi-point (CoMP) transmission.

13. The method of claim 12, further comprising transmitting, by the anchor node, communication signals to a subset of the backhaul reporting set,
wherein the subset comprises a transmission set of the anchor node relative to the user equipment, and
wherein the communication signals comprise beamforming information and pre-coding vectors selected to maximize received signal strength at the user equipment anchored to the anchor node or to minimize interference to the user equipment anchored to the adjacent nodes.

14. The method of claim 12, wherein evaluating at the anchor node the utility of incorporating the adjacent node into the backhaul reporting set of the anchor node comprises:
selecting a node adjacent to a node in the BRS of the anchor node;
selecting a lowest data rate UE anchored to the anchor node;
selecting a maximum signal candidate node and a minimum interference candidate node from nodes in a radio reporting set of the selected UE not in the BRS of the anchor node; and
appending one of the maximum signal candidate node and the minimum interference candidate node to the BRS of the anchor node.

15. The method of claim 14, further comprising transmitting channel state information and scheduling information from the anchor node to nodes in the backhaul reporting set of the anchor node.

16. The method of claim 12, wherein the backhaul reporting set comprises a transmission set of the anchor node, wherein the measurement set of the user equipment comprises a radio reporting set of the user equipment.

17. An apparatus, comprising:
a processor; and
a memory comprising processor executable instructions that, when executed by the processor, configures the apparatus to:
detect a plurality of nodes in a communication network;
select a subset of the plurality of nodes based on a utility of incorporating the subset in a communication group for a coordinated multi-point (CoMP) transmission; and
report the subset within the communication network.

18. The apparatus of claim 17, configured as a user equipment,
wherein to detect the plurality of nodes, the user equipment is configured to receive signals from nodes in a measurement set of the user equipment, the measurement set comprising nodes in the communication network for which the user equipment is capable of performing signal measurements, and
wherein to report the selection, the user equipment is configured to transmit channel status information on the subset from the user equipment to an anchor node of the user equipment, the subset comprising a radio reporting set (RRS) of the user equipment.

19. The apparatus of claim 17, configured as an anchor node,
wherein to detect the plurality of nodes, the anchor node is configured to receive communication signals over a backhaul network, the communication signals comprising channel status reports from adjacent nodes of the anchor node on user equipment anchored to the anchor node and user equipment anchored to the adjacent nodes, and
wherein to select the subset, the anchor node is configured to evaluate a utility of incorporating the adjacent nodes into a backhaul reporting set of the anchor node.

20. The apparatus of claim 19, wherein the anchor node is configured to transmit communication signals to a subset of the backhaul reporting set,
wherein the subset comprises a transmission set of the anchor node relative to the user equipment, and
wherein the communication signals comprise beamforming information and pre-coding vectors selected to maximize received signal strength at the user equipment anchored to the anchor node or to minimize interference to the user equipment anchored to the adjacent nodes.

21. The apparatus of claim 19, wherein to evaluate the utility of incorporating the adjacent node into the backhaul reporting set, the anchor node is configured to:
select a node adjacent to a node in the BRS of the anchor node;
select a lowest data rate UE anchored to the anchor node;
select a maximum signal candidate node and a minimum interference candidate node from nodes in a radio reporting set of the selected UE not in the BRS of the anchor node; and
append one of the maximum signal candidate node and the minimum interference candidate node to the BRS of the anchor node.

22. An article of manufacture, comprising a non-transitory machine-readable medium having instructions therein that, when executed by a machine, configure the machine to:
detect a plurality of nodes in a communication network;
select a subset of the plurality of nodes based on a utility of incorporating the subset in a communication group for a coordinated multi-point (CoMP) transmission; and
report the subset within the communication network.

23. The article of manufacture of claim 22, further having instructions that configure the machine as a user equipment,
wherein to detect the plurality of nodes, the user equipment is configured to receive signals from nodes in a measurement set of the user equipment, the measurement set comprising nodes in the communication network for which the user equipment is capable of performing signal measurements, and
wherein to report the selection, the user equipment is configured to transmit channel status information on the subset from the user equipment to an anchor node of the user equipment, the subset comprising a radio reporting set of the user equipment.

24. The article of manufacture of claim 22, further having instructions that configure the machine as an anchor node,
wherein to detect the plurality of nodes, the anchor node is configured to receive communication signals over a backhaul network, the communication signals comprising channel status reports from adjacent nodes of the anchor node on user equipment anchored to the anchor node and user equipment anchored to the adjacent nodes, and
wherein to select the subset, the anchor node is configured to evaluate a utility of incorporating the adjacent nodes into a backhaul reporting set of the anchor node.

25. The article of manufacture of claim 24, having further instructions that configure the anchor node to transmit communication signals to a subset of the backhaul reporting set,
wherein the subset comprises a transmission set of the anchor node relative to the user equipment, and
wherein the communication signals comprise beamforming information and pre-coding vectors selected to maximize received signal strength at the user equipment anchored to the anchor node or to minimize interference to the user equipment anchored to the adjacent nodes.

26. The article of manufacture of claim 24, wherein to evaluate the utility of incorporating the adjacent node into the backhaul reporting set, the anchor node is configured to:
select a node adjacent to a node in the BRS of the anchor node;
select a lowest data rate UE anchored to the anchor node;
select a maximum signal candidate node and a minimum interference candidate node from nodes in a radio reporting set of the selected UE not in the BRS of the anchor node; and
append one of the maximum signal candidate node and the minimum interference candidate node to the BRS of the anchor node.

27. An apparatus, comprising:
means for detecting a plurality of nodes in a communication network;
means for selecting a subset of the plurality of nodes based on a utility of incorporating the subset in a communication group for a coordinated multi-point (CoMP) transmission; and
means for reporting the subset within the communication network.

28. The apparatus of claim 27, configured as a user equipment,
wherein the means for detecting the plurality of nodes comprises means for receiving signals from nodes in a measurement set of the user equipment, the measurement set comprising nodes in the communication network for which the user equipment is capable of performing signal measurements, and
wherein reporting the subset comprises transmitting channel status information on the subset from the user equipment to an anchor node of the user equipment, the subset comprising a radio reporting set of the user equipment.

29. The apparatus of claim 27, configured as an anchor node,
wherein the means for detecting the plurality of nodes comprises means for receiving communication signals over a backhaul network at the anchor node, the communication signals comprising channel status reports from adjacent nodes of the anchor node on user equipment anchored to the anchor node and user equipment anchored to the adjacent nodes, and
wherein the means for selecting the subset comprises means for evaluating at the anchor node a utility of incorporating the adjacent nodes into a backhaul reporting set of the anchor node.

30. The apparatus of claim 29, further comprising means for transmitting communication signals to a subset of the backhaul reporting set, wherein the subset comprises a transmission set of the anchor node relative to the user equipment, and
wherein the communication signals comprise beamforming information and pre-coding vectors selected to maximize received signal strength at the user equipment anchored to the anchor node or to minimize interference to the user equipment anchored to the adjacent nodes.

31. The apparatus of claim 29, wherein the means for evaluating the utility of incorporating the adjacent node into the backhaul reporting set of the anchor node comprises:
means for selecting a node adjacent to a node in the BRS of the anchor node;
means for selecting a lowest data rate UE anchored to the anchor node;
means for selecting a maximum signal candidate node and a minimum interference candidate node from nodes in a radio reporting set of the selected UE not in the BRS of the anchor node; and
means for appending one of the maximum signal candidate node and the minimum interference candidate node to the BRS of the anchor node.
